(19) United States
(12) Patent Application Publication
(10) Pub. No.: US 2026/0220064 A1
(43) Pub. Date: Jul. 30, 2026

(54) METHOD AND APPARATUS FOR IDENTIFYING PCI DEVICES, ELECTRONIC DEVICE AND READABLE STORAGE MEDIUM

(71) Applicant: SUZHOU METABRAIN INTELLIGENT TECHNOLOGY CO., LTD., Suzhou, Jiangsu (CN)

(72) Inventors: Muqing TIAN, Suzhou, Jiangsu (CN); Zhaonan NING, Suzhou, Jiangsu (CN); Binghui ZHANG, Suzhou, Jiangsu (CN); Fanyi YAO, Suzhou, Jiangsu (CN); Juan ZHAO, Suzhou, Jiangsu (CN); Bo LI, Suzhou, Jiangsu (CN); Xiuqiang SUN, Suzhou, Jiangsu (CN)

(21) Appl. No.: 19/148,002

(22) PCT Filed: Sep. 29, 2024
(86) PCT No.: PCT/CN2024/122304

§ 371 Date: Jul. 15, 2025

(30) Foreign Application Priority Data
Dec. 1, 2023 (CN) 202311640891.2

(51) Int. Cl. G06F 13/42

(52) U.S. Cl. CPC G06F 13/4221; G06F 2213/0024

(57) ABSTRACT

The present application relates to the technical field of computers, and provides a method and apparatus for identifying PCI devices, an electronic device and a nonvolatile readable storage medium. The method comprises: acquiring a configuration file of a processor; on the basis of the configuration file, determining an identification sequence of interfaces, and generating an identification sequence list; in response to an identification sequence position modification request, modifying in a basic input output system the identification sequence position of a target interface in the identification sequence list, and adjusting the sequence position of a port resource identifier corresponding to the interface of which the identification sequence position has changed, so as to generate a new identification sequence list; and, according to the new identification sequence list, scanning PCI devices connected to the processor.

### CROSS-REFERENCE TO RELATED APPLICATION

The present disclosure claims priority to Chinese Patent Application No. 202311640891.2, entitled “METHOD AND APPARATUS FOR IDENTIFYING PCI DEVICES, ELECTRONIC DEVICE, AND READABLE STORAGE MEDIUM”, filed on Dec. 1, 2023, by the China Patent Office, the entire contents of which are incorporated herein by reference.

### TECHNICAL FIELD

The present disclosure relates to the field of computer technology, and more particularly, to a method and an apparatus for identifying a PCI device, an electronic device, and a readable storage medium.

### BACKGROUND

Artificial Intelligence (AI) servers often require a large number of GPU (graphics processing unit)/network interface card devices to perform operations. Due to the limitation of the quantity of slots, many switch boards are often required to perform slot position expansion, and there are many GPU and network interface cards on each switch board. For maximum performance of the GPU, the order in which each port is connected to the CPU is designed, which results in a fixed order identifying the PCI (Peripheral Component Interconnect) devices.

Taking a network interface card as an example, if it is desired to designate a network interface card with another interface as the first identified network interface card under the operating system, it can only be performed by changing the insertion position of the above-mentioned network interface card.

In the event that a large number of changes in the order in which the PCI devices are identified are required, the above-described method is labor intensive and may have some impact on the performance of the server.

### SUMMARY

In view of the foregoing, embodiments of the present disclosure have been developed to provide a method and an apparatus for identifying a PCI device, an electronic device, and a readable storage medium for identifying a PCI device that overcomes, or at least partially solves, the foregoing problems.

In the first aspect, there is disclosed a method for identifying a PCI device including:
acquiring a configuration file of a processor;
determining an identification order of each interface according to the configuration file, and generating an identification order list;
modifying an identification order of a target interface in the identification order list in a basic input output system in response to an identification order modification request, and adjusting an order of a port resource identifier corresponding to an interface of which the identification order is changed, to generate a new identification order list; and
scanning a PCI device to which the processor is connected according to the new identification order list.

Optionally, the modifying an identification order of a target interface in the identification order list in a basic input output system, and adjusting an order of a port resource identifier corresponding to an interface of which the identification order is changed comprises:
after modifying the identification order of the target interface in the identification order list in the basic input output system, comparing the adjusted identification order of the interface with a default identification order list to determine whether there is a change in the identification order of the interface; and
adjusting the order of port resource identifiers corresponding to the interface of which the identification order is changed in a condition that it is determined that there is a change in the identification order of the interface.

Optionally, the adjusting the order of port resource identifiers corresponding to the interface of which the identification order is changed in a condition that it is determined that there is a change in the identification order of the interface includes:
determining a target interface which identifies the order change; and
modifying the order of the port resource identifier, so that the order of the port resource identifier corresponds to the identification order of the modified target interface.

Optionally, the modifying an identification order of a target interface in the identification order list by a basic input output system in response to an identification order modification request includes:
displaying a menu option for adjusting the recognition sequence in a setting interface of the basic input output system;
displaying a default identification order list in response to a first input to the menu option; and
modifying the identification order of the target interfaces in the identification order list in response to the identification order modification request for the identification order list.

Optionally, the identification order is modified remotely by the basic input output system.

Optionally, a first input is an input into a menu for adjusting the identification order.

Optionally, the modifying the identification order of the target interfaces in the identification order list in response to the identification order modification request for the identification order list includes:
exchanging the identification orders of any two interfaces in the identification order list in response to the identification order modification request for the identification order list.

Optionally, the determining an identification order of each interface according to the configuration file, and generating an identification order list includes:
determining a model of the processor according to the configuration file; and
generating an identification order list based on the model of the processor.

Optionally, the determining a model of the processor according to the configuration file includes:
reading a model identifier of the processor from the configuration file; and
determining a model of the processor according to the model identifier.

Optionally, the generating an identification order list based on the model of the processor includes:
determining an interface topology order of the processor according to the model of the processor; and
converting the interface topology order into an order arrangement, and generating an identification order list.

Optionally, the scanning a PCI device to which the processor is connected according to the new identification order list includes:
scanning an PCI device according to the new identification order list, and acquiring an address identifier of the PCI device;
acquiring information of the PCI device according to the address identifier and outputting same; and
continuing a self-test process of the next interface according to the identification order list.

Optionally, the acquiring information about the PCI device according to the address identifier and outputting same includes:
acquiring a device type and manufacturer information about the PCI device and outputting according to the address identifier; and
accessing a configuration space of the PCI device, and outputting configuration information about the PCI device, in a condition that the level of the PCI device complies with a pre-set level condition.

Optionally, the method further includes continuing a self-test procedure in a condition that the level of the PCI device does not comply with the pre-set level condition.

Optionally, the configuration space is a register mapped to each interface card.

Optionally, the method further includes:
reading the configuration space of each of the interface cards by the basic input output system when a mainboard is powered on;
allocating a resource required by each of the interface cards by the basic input output system to obtain an allocation result; and
writing the allocation result into an address of the configuration space corresponding to each of the interface cards to complete automatic configuration of each of the interface cards.

Optionally, the port resource identifier includes a bandwidth port identifier and an asset information port identifier.

Optionally, the address identifier is a BDF number, and the BDF number includes a bus number, a device number, and a function number.

In a second aspect, there is provided an apparatus for identifying a PCI device including:
an acquisition module configured for acquiring a configuration file of a processor;
a generation module configured for determining an identification order of each interface according to the configuration file, and generating an identification order list;
a modification module configured for modifying an identification order of a target interface in the identification order list by a basic input output system in response to an identification order modification request, and adjusting an order of port resource identifier corresponding to an interface of which the identification order is changed, to generate a new identification order list; and
an identification module configured for scanning a PCI device to which the processor is connected according to the new identification order list.

In a third aspect, there is provided an electronic device, including a processor and a memory, wherein the memory stores a program or instructions executable on the processor, which when executed by the processor perform the steps of the method above.

In a fourth aspect, there is provided a non-volatile readable storage medium, wherein the non-volatile readable storage medium has stored thereon a program or instructions which when executed by a processor perform the steps of the method above.

In an embodiment of the present disclosure, the method includes acquiring a configuration file of a processor; determining an identification order of each interface according to the configuration file, and generating an identification order list; modifying an identification order of a target interface in the identification order list by a basic input output system in response to an identification order modification request, and adjusting an order of port resource identifier corresponding to an interface of which the identification order is changed, to generate a new identification order list; and scanning a PCI device to which the processor is connected according to the new identification order list. The present disclosure provides a scheme that can modify the scanning order of PCI by BIOS (Basic Input Output System), without the need to modify the insertion method of the device offline and without the need to cut off the power supply. The scanning order of the PCI device is modified in the software level, and the port resource identifier order corresponding to the interface of which the identification order is changed is modified synchronously, to ensure the correctness of the asset information corresponding to the PCI device. Since there is no need to worry that the performance of hardware is affected by the identification order, the identification order of the PCI device can be changed without affecting the performance.

### BRIEF DESCRIPTION OF THE DRAWINGS

In order to more clearly illustrate the embodiments of the present disclosure or the technical solutions in the prior art, a brief description will be given below of the drawings used as required in the description of the embodiments.

FIG. 1 shows a connection mode of a PCI device according to an embodiment of the present disclosure;

FIG. 2 shows a method for identifying the PCI device according to an embodiment of the present disclosure;

FIG. 3 shows yet another method for identifying the PCI device according to an embodiment of the present disclosure;

FIG. 4 is a flow diagram for identifying PCI device information according to an embodiment of the present disclosure;

FIG. 5 is a flow diagram of a method for changing an identification order of the PCI device according to an embodiment of the present disclosure;

FIG. 6 is a block diagram of an apparatus for identifying the PCI device according to an embodiment of the present disclosure;

FIG. 7 shows an electronic device according to an embodiment of the present disclosure;

FIG. 8 shows yet another electronic device according to an embodiment of the present disclosure.

### DETAILED DESCRIPTION OF THE EMBODIMENTS

Some embodiments of the present disclosure are provided. However, it should be understood that the present disclosure may be embodied in various forms and should not be construed as limited to the embodiments set forth herein. Rather, these embodiments are provided so that the present disclosure will be thorough and complete, and will fully convey the scope of the present disclosure to those skilled in the art.

The concepts and backgrounds associated with the present disclosure are explained in the following.

The PCI (Peripheral Component Interconnect, the local bus standard) bus is mainly divided into three parts.

PCI devices: those devices that conform to the PCI bus standard are referred to as PCI devices, and a PCI bus architecture may include a plurality of PCI devices. The PCI device is also divided into a master device and a target device. The master device is the initiator of an access operation, and the target device is the interviewee. In an embodiment of the present disclosure, the PCI devices may be devices that communicate via the PCI protocol, all of which may communicate with the processor via the PCI protocol, or the devices may communicate with each other via the processor.

PCI bus: Multiple PCI buses can be in the system, which is similar to a tree structure for expansion. Each PCI bus can connect multiple PCI devices/bridges.

The PCI bridge can be extended by a new PCI bus when the capacity of a PCI bus is not enough, and the PCI bridge is a link connecting the PCI buses.

The PCI space is isolated from the processor space. The PCI device has an independent address space, i.e., the PCI bus address space, which is isolated from the memory address space by a Host bridge. The processor is required to access the PCI device by the Host bridge, and the PCI device is required to access the main memory by the Host bridge. There are many buffers in the Host bridge that allow the processor bus and the PCI bus to operate at their respective clock frequencies without interfering with each other. The presence of the Host bridge also allows the PCI device and the processor to conveniently share main memory resources. When a processor accesses a PCI device, the address conversion must be performed via the Host bridge. When the PCI device accesses the main memory, it is also required to perform the address conversion by the Host bridge.

PCI is a standard introduced by Intel Corporation in 1991 for defining local busses. This standard allows up to 10 expansion cards conforming to the PCI standard to be installed in a computer. The first proposed PCI bus works at the frequency of 33 MHz, and the transmission bandwidth reaches 132 MB/s (33 MHz*32 bit/8), which basically meets the development needs of the processors at that time.

The PCI bus has a strong scalability. In the PCI bus, Root Bridge can directly connect a PCI bus, which is also the first PCI bus managed by the Root bridge. The PCI bus can also extend a series of PCI buses by the PCI bridge, and take the Root bridge as the root node to form a PCI bus tree. Direct communication between devices on the same PCI bus does not affect the communication of data between devices on other PCI buses. PCI devices that belong to the same PCI bus tree can also communicate directly, but need to forward data through the PCI bridge.

The Basic input output system (BIOS) is a set of programs which are fixed to a ROM processor on the mainboard of the computer. It stores the most important basic input and output programs of the computer, the self-test program after starting up and the system self-start program. It can read and write the specific information of the system settings from CMOS. Its main function is to provide the lowest level, most direct hardware setup and control for the computer. In addition, BIOS provides some of the system parameters to the work system. The changes to the system hardware are hidden by the BIOS, and the program uses the BIOS function instead of directly controlling the hardware.

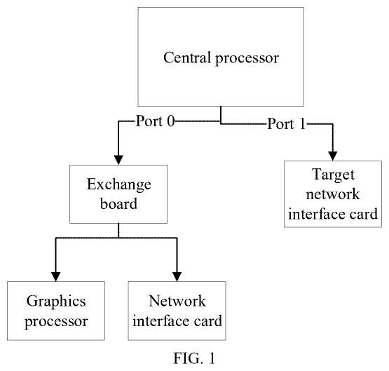

With reference to FIG. 1, FIG. 1 shows a connection mode of a PCI device. When reading a PCI device, the connection mode includes firstly reading a port 0, reading a network interface card provided under the port 0, and then reading a target network interface card via the port 1. If the target network interface card is to be read first, the position of the target network interface card is required to be changed, and the target network interface card can only be inserted into a switchboard under the port 0. In the above-mentioned mode, when there are more PCI devices needing to change an identification order, the efficiency is low. Therefore, the present disclosure proposes a method for identifying a PCI device, which is used for changing an identification order of the PCI device, to realize the function of reading a target network interface card firstly without changing the slot position of the target network interface card.

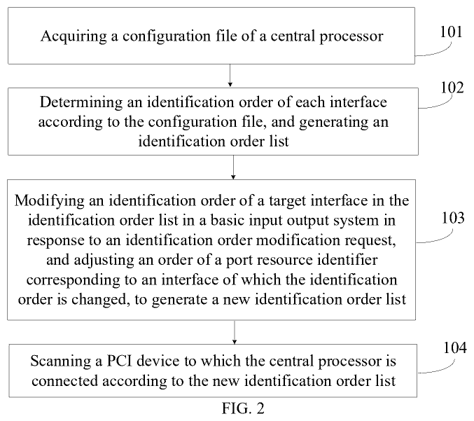

Referring to FIG. 2, it shows a flow chart of the steps of a a method for identifying the PCI device according to an embodiment of the present disclosure, the method including:

Step 101, acquiring a configuration file of a processor.

In an embodiment of the present disclosure, the configuration file of the processor may be a file that holds the start-up order of the processor. Here, the processor may be a central processor.

In the present disclosure, the Intel XCC model CPU (processor) is taken as an example, and the other types of CPU methods are similar. First, XCC is introduced. The topology of XCC CPU is not arranged in the order of PE0/1/2/3/4, but the order of PE0/4/2/1/3, out of order. After the configuration file is acquired, the model of the processor can be determined by reading an identifier characterizing the model of the processor in the configuration file, the processors of different models have different numbers of PEs and PE identification orders. After the model of the processor is determined, the PE identification orders can be determined based on the model of the processor.

Step 102, determining the identification order of each interface according to the configuration file, and generating an identification order list.

In the embodiment of the present disclosure, during the BIOS post phase (power-on self-test), when initializing the CPU, the PE mapping of the CPU, i.e., a configuration file of a processor, is acquired firstly. If the PE mapping exists and is judged to be a XCC model, a conversion table is set up to convert the topology of the XCC into a sequential arrangement, and the subsequent initialization of the CPU will be performed according to the converted PE mapping in this step. During the Post medium-term, it enters the PCI initialization phase, and BIOS performs scan configuration according to the currently converted PE order. BIOS can seize this rule and optimize the logic to a discretionary scheme.

Referring to Table 1, it shows the contents of the above conversion table. The identification order of the PEs can be converted into the following order according to the model of the processor. In the identification, the identification is performed in the order of PE0, PE4, PE2, PE1 and PE3, rather than PE0, PE1, PE2, PE3 and PE4, and the conversion tables corresponding to different types of processors are different.

TABLE 1

| BIOS Mapping | XCC Socket Ports |
|---|---|
| DMI | DMI |
| Port1 | PE0 |
| Port2 | PE4 |
| Port3 | PE2 |
| Port4 | PE1 |
| Port5 | PE3 |

Step 103, modifying an identification order of a target interface in the identification order list in a basic input output system in response to an identification order modification request, and adjusting an order of port resource identifier corresponding to an interface of which the identification order is changed, to generate a new identification order list.

In an embodiment of the present disclosure, a menu “Modify Scan Order” may be added to the BIOS's setup list of options to support any adjustment of the order of PE0, PE1, PE2, PE3, PE4, etc. Before adjusting the order, it should be noted that the change of the order of the PEs may lead to the confusion of the original bandwidth allocation and asset information assignment of each port of the PEs, because the index (which can be understood to be the port number of the device connected to each port, namely, the port resource identifier in the present disclosure) on the PEs are sequentially set according to the initial order. For example, if PE1 is modified to scan preferentially over PE0, the index order of PE0 and PE1 is required to be synchronously changed, otherwise, the phenomenon that the bandwidth and asset information are reversed may occur. In these positions required to be reversed, a corresponding interface in the setup option is added. When the PE interface sequence is adjusted, the corresponding PE port firstly is required to compare whether the current order and the order modified by the user have changed₀ If the user exchanges PE4 with PE1, the underlying logic of the BIOS is required to exchange the bandwidth port and asset information port of the original PE1 with PE4. The on-line modification of PE scan order is implemented to change the scan order of PCI.

In an embodiment of the present disclosure, after modifying the identification order list, the BIOS may read a new identification order list, and modify a corresponding conversion table of the processor according to the new identification order list, to realize the modification of the configuration file of the processor, thereby changing the identification order of the interface. Taking the above-mentioned table 1 as an example, the BIOS can modify the identification order of the target interfaces (PE0, PE4, PE2, PE1 and PE3) in the above-mentioned Table 1 according to a new identification order list, and modify the order of port resource identifiers (Port1, Port2, Port3, Port4 and Port5) corresponding to the interfaces of which the identification order is changed in the above-mentioned Table 1, to realize the modification of the processor configuration file, thereby changing the identification order of the interfaces.

Step 104, scanning the PCI device to which the processor is connected according to the new identification order list.

In an embodiment of the present disclosure, after adjusting the identification order, the PCI device to which the processor is connected may be scanned based on the new identification order list. Taking FIG. 1 as an example, during scanning, the target network interface card of the port 1 can be scanned firstly, and then the network interface card under the port 1 can be scanned by means of software, so that the scanning order can be realized by user-defined.

Furthermore, the BIOS can remotely and independently modify the recognition sequence of PCI, so that it is very easy to modify the main network interface card under the operating system, cooperate with the testing of the operating system, etc. during actual use. The present disclosure significantly enhances the practicability of the BIOS, realizes the remote modification of the scanning order of the PCI without needing to go off-line to the scene. The realization can not only change the identification order of the PCI device, but also does not affect the performance, which greatly improves the practicability of the BIOS, and meets the requirements of a variety of test scenarios for customers.

In an embodiment of the present disclosure, the method includes acquiring a configuration file of a processor; determining an identification order of each interface according to the configuration file, and generating an identification order list; modifying an identification order of a target interface in the identification order list by a basic input output system in response to an identification order modification request, and adjusting an order of port resource identifier corresponding to an interface of which the identification order is changed, to generate a new identification order list; and scanning a PCI device to which the processor is connected according to the new identification order list. The present disclosure provides a scheme that can modify the scanning order of PCI through BIOS, without the need to modify the insertion method of the device offline and without the need to cut off the power supply. The scanning order of the PCI device is modified in the software level, and the port resource identifier order corresponding to the interface of which the identification order is changed is modified synchronously, to ensure the correctness of the asset information corresponding to the PCI device. Since there is no need to worry that the performance of hardware is affected by the identification order, the identification order of the PCI device can be changed without affecting the performance.

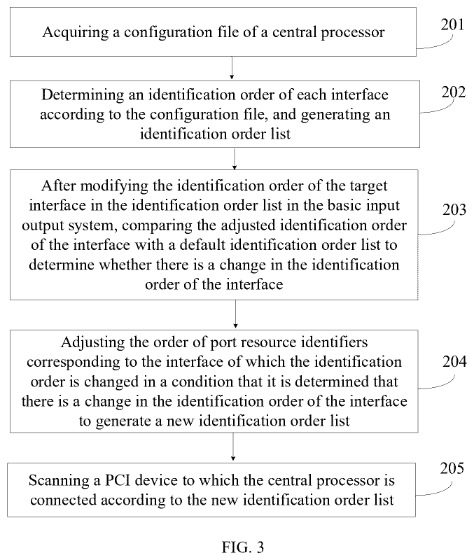

Referring to FIG. 3, it shows a flow chart of the steps of yet another method for identifying the PCI device according to an embodiment of the present disclosure, the method including:

Step 201, acquiring a configuration file of a processor.

This step may be referred to as Step 101 and will not be described in further detail herein.

Step 202, determining the identification order of each interface according to the configuration file, and generating an identification order list.

This step may be referred to as the step 102 and will not be described in further detail herein.

Optionally, Step 202 includes:
sub-step 2021, determining the model of the processor according to the configuration file.

In an embodiment of the present disclosure, for the sub-step 2021, the SKU information of the processor may be included in the configuration file. In the CPU model, SKU refers to a variety of different models of CPU, usually made up of several numbers. These numbers represent different parameters of the CPU, including the quantity of cores, the quantity of threads, the base frequency, the maximum frequency, and so on. For example, “8700” in the Intel Core i7-8700K represents the performance level of this model.

Optionally, the sub-step 2021 includes:
sub-step 20211, reading the model identifier of the processor from the configuration file;
sub-step 20212, determining the model of the processor according to the model identifier.

In the embodiment of the present disclosure, specific reference is made to the description of sub-step 2021 for the sub-step 20211 and the sub-step 20212, the model identifier, i.e., SKU information of CPU, which will not be described in detail here.
sub-step 2022, generating an identification order list according to the model of the processor.

Optionally, the sub-step 2022 includes:
sub-step 20221, determining an interface topology order of the processor according to the model of the processor; and
sub-step 20222, converting the interface topology order into an order arrangement to generate an identification order list.

In the embodiment of the present disclosure, with regard to the sub-step 20221 and the sub-step 20222, the interface topological order of processors of different models is different.

Taking the Intel XCC model CPU as an example, during the BIOS post phase (power-on self-test), when initializing the CPU, the PE mapping of the CPU, i.e., a configuration file of a processor, is acquired firstly. If the PE mapping exists and is judged to be a XCC model, a conversion table is set up to convert the topology of the XCC into a sequential arrangement, and the subsequent initialization of the CPU will be performed according to the converted PE mapping in this step. The identification order list after the XCC conversion is the order of PE0, PE4, PE2, PE1 and PE3.

Step 203, after the basic input output system modifies the identification order of the target interface in the identification order list, the adjusted identification order of the interface is compared with a default identification order list to determine whether there is a change in the identification order of the interface.

In an embodiment of the present disclosure, a menu “Modify Scan Order” may be added to the BIOS's setup list of options to adjust the order of PE0, PE1, PE2, PE3, PE4, etc. After the identification order of PEs is adjusted based on the basic input output system, the corresponding PE port first is required to compare whether the current order changes with respect to the order modified by the user. For example, if the user exchanges the PE4 with the PE1, the BIOS underlying logic is required to exchange the original PE1 bandwidth port and asset information port with the PE4. The on-line modification of PE scan order is implemented to change the scan order of PCI.

Optionally, the step 203 includes:
sub-step 2031, displaying a menu option for adjusting the recognition sequence in a setting interface of the basic input output system;
sub-step 2032, displaying a default identification order list in response to a first input to the menu option; and
sub-step 2033, modifying the identification order of the target interfaces in the identification order list in response to the identification order modification request for the identification order list.

In the embodiment of the present disclosure, with regard to the sub-step 2031 to the sub-step 2033, a menu option for adjusting a recognition sequence can be displayed on a setting interface of a basic input output system. That is to say, after a user enters the basic input output system, the recognition sequence of PEs can be adjusted on the basis of the menu option quickly.

Furthermore, if a user performs a first input on a menu option, the first input may be an input into a menu for adjusting a identification order, and a default identification order list may be displayed on a setting interface of a basic input output system. Taking a Intel XCC model CPU as an example, the default identification order list may be PE0, PE4, PE2, PE1 and PE3, and the user may adjust the identification order by adjusting the menu option of the identification order. For example, PE4, PE0, PE2, PE1 and PE3 may be adjusted.
sub-step 2032, displaying a default identification order list in response to a first input to the menu option; and
sub-step 2033, modifying the identification order of the target interfaces in the identification order list in response to the identification order modification request for the identification order list.

In the embodiment of the present disclosure, with regard to the sub-step 2032 and the sub-step 2033, if a user performs a first input on a menu option, the first input may be an input into a menu for adjusting a identification order, and a default identification order list may be displayed on a setting interface of a basic input output system. Taking a Intel XCC model CPU as an example, the default identification order list may be PE0, PE4, PE2, PE1 and PE3, and the user may adjust the identification order by adjusting the menu option of the identification order. For example, the positions of PE0 and PE4 can be interacted. The default identification order is adjusted to PE4, PE0, PE2, PE1, PE3.

In addition, the order of identification of PEs may be modified in any manner based on actual needs, and the embodiments of the present disclosure are not limited thereto.

Optionally, the sub-step 2033 includes:
sub-step 20331, exchanging the identification orders of any two interfaces in the identification order list in response to the identification order modification request for the identification order list.

This step can be referred to as the sub-step 2032 and the sub-step 2033 and will not be described in detail here.

Step 204, adjusting the order of port resource identifiers corresponding to the interface of which the identification order is changed in a condition that it is determined that there is a change in the identification order of the interface to generate a new identification order list.

In the embodiment of the present disclosure, the change of the order of the PEs may lead to the confusion of the original bandwidth allocation and asset information assignment of each port of the PEs, because the index (which can be understood to be the port number of the device connected to each port, namely, the port resource identifier in the present disclosure) on the PEs are sequentially set according to the initial order. For example, if PE1 is modified to scan preferentially over PE0, the index order of PE0 and PE1 is required to be synchronously changed, otherwise, the phenomenon that the bandwidth and asset information are reversed may occur. In these positions required to be reversed, a corresponding interface in the setup option is added. When the PE interface sequence is adjusted, the corresponding PE port firstly is required to compare whether the current order and the order modified by the user have changed. If the user exchanges PE4 with PE1, the underlying logic of the BIOS is required to exchange the bandwidth port and asset information port of the original PE1 with PE4. The on-line modification of PE scan order is implemented to change the scan order of PCI.

Optionally, the step 204 includes:
sub-step 2041, determining a target interface which identifies the order change; and
sub-step 2042, modifying the order of port resource identifier, so that the order of port resource identifier corresponds to the identification order of the modified target interface.

In the embodiment of the present disclosure, with regard to the sub-step 2041 and the sub-step 2042, since the order of the interfaces is consistent with the access order of the resources corresponding to the interfaces, if the identification order of the interfaces is modified, the access order of the resources should be correspondingly modified. For example, if a user exchanges PE4 with PE1, the BIOS underlying logic is required to exchange the original PE1 bandwidth port and asset information port with PE4. The on-line modification of PE scan order is implemented to change the scan order of PCI. The present disclosure provides a scheme that can modify the scanning order of PCI through BIOS, without the need to modify the insertion method of the device offline and without the need to cut off the power supply. The scanning order of the PCI device is modified in the software level, and the port resource identifier order corresponding to the interface of which the identification order is changed is modified synchronously, to ensure the correctness of the asset information corresponding to the PCI device. Since there is no need to worry that the performance of hardware is affected by the identification order, the identification order of the PCI device can be changed without affecting the performance.

Step 205, the PCI device to which the processor is connected is scanned according to the new identification order list.

This step may be referred to as the step 101 and will not be described in further detail herein.

Sub-step 2051, scanning the PCI device according to the new identification order list, and the address identifier of the PCI device is acquired.

Sub-step 2052, acquiring relevant information about the PCI device according to the address identifier and the same is output.

In the embodiment of the present disclosure, with regard to the sub-step 2051 and the sub-step 2052, after the identification order of the interface is modified, the PCI device is scanned according to the new identification order list, and the address identifier of the PCI device is acquired.

Furthermore, the address identifier of the PCI device can be a BDF number corresponding to the PCI device, and a PCI device can be uniquely determined in the system based on the BDF number. A configuration space of the PCI device is accessed to read relevant information about the PCI device. The relevant information can be information such as the manufacturer and model of the PCI device.

Optionally, the sub-step 2052 includes:
sub-step 20521, acquiring a device type and manufacturer information about the PCI device according to the address identifier and the same is output; and
sub-step 20522, in a condition that the level of the PCI device complies with a pre-set level condition, accessing a configuration space of the PCI device, and outputting the configuration information about the PCI device.

In the embodiment of the present disclosure, with regard to the sub-step 20521 and the sub-step 20522, according to the address identifier, the device type and manufacturer information about the PCI device can be acquired and output. In addition, in a condition that the level of the PCI device meets the pre-set level condition, the configuration space of the PCI device can be accessed to output configuration information about the PCI device. If the level of the PCI device does not meet the pre-set level condition, the self-test program can be continued.

Sub-step 2053, continuing the self-test process of the next interface according to the identification order list.

In an embodiment of the present disclosure, after a PCI device has been identified, the process of self-test of the next interface is continued based on the new identification order list.

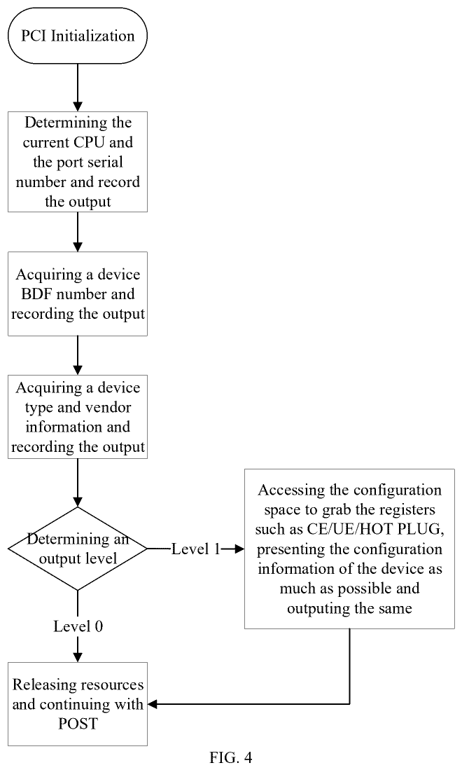

Referring to FIG. 4, it shows a flow chart for identifying PCI device information provided by an embodiment of the present disclosure, including: initializing the PCI, deciding the serial number of the current CPU and port and recording the output, acquiring the BDF number of the device and recording the output, acquiring the device type and manufacturer information and records the output, and deciding the output level. If the level is level 1, the configuration space is accessed to grab registers such as CE/UE/HOT PLUG, and the configuration information of the device is presented as much as possible and the same is output. If the level is level 0, the resources are released and the self-test process is continued.

In an embodiment of the present disclosure, the method includes acquiring a configuration file of a processor; determining an identification order of each interface according to the configuration file, and generating an identification order list; modifying an identification order of a target interface in the identification order list by a basic input output system in response to an identification order modification request, and adjusting an order of port resource identifier corresponding to an interface of which the identification order is changed, to generate a new identification order list; and scanning a PCI device to which the processor is connected according to the new identification order list. The present disclosure provides a scheme that can modify the scanning order of PCI through BIOS, without the need to modify the insertion method of the device offline and without the need to cut off the power supply. The scanning order of the PCI device is modified in the software level, and the port resource identifier order corresponding to the interface of which the identification order is changed is modified synchronously, to ensure the correctness of the asset information corresponding to the PCI device. Since there is no need to worry that the performance of hardware is affected by the identification order, the identification order of the PCI device can be changed without affecting the performance.

Optionally, the port resource identifier includes a bandwidth port identifier and an asset information port identifier.

In embodiments of the present disclosure, the computer resources such as I/O ports, the memory space, the interrupts, and DMA are typically used by computer interface cards. PCI interface card, which is used by software to allocate resources as a whole. In order to achieve this function, the PCI protocol can read and write to the I/O space and the memory space, and also define the read and write to the configuration space (C/BE0-C/BE3=1010, 1011). The configuration space is meant to be a 256-byte special function register that is mapped onto each block of interface cards. And after the main board is powered on, a PnP-Bios (Plug and Play BIOS, a basic input output system supporting plug-and-play) reads configuration spaces of various cards, allocates resources required thereby in an overall manner, and writes an allocation result back to a corresponding configuration space address to complete automatic configuration.

Optionally, the address identifier is a BDF number, and wherein the BDF number includes a bus number, a device number, and a function number.

In an embodiment of the present disclosure, if the configuration space of the PCI device is to be accessed, the physical connection of this device in the system must be known. The data BDF numbers (Bus, Device, Function) describing this connection case are the “bus number”, the “device number” and the “function number”. A system may have 256 PCI buses, 32 devices on each bus, and 8 functions for each device (each function as a PCI device). When these three data are determined, one PCI device can be uniquely determined in the system. By writing the bus number (8 bits), the device number (5 bits), the function number (3 bits) of the PCI device and the offset address of the configuration space into 0xCF8, the configuration value of the corresponding location can be accessed via the 0xCFC port. Access to the PCI device under DOS typically uses the PCI BIOS service function, and the PCI BIOS can be called by executing the INT 1AH instruction.

Specifically, BUS is the bus number, up to 256 bus numbers can be assigned by the configuration software. The initial bus number, bus 0, is typically assigned to the Root Complex by hardware. Bus 0 consists of a virtual PCI bus with integrated endpoints and a virtual PCI-to-PCI bridge (P2P) with a hard-coded device number and function number. Each P2P bridge creates a new bus to which additional PCIe devices can be connected. Each bus must be assigned with a unique bus number. The configuration software starts assigning bus numbers by searching for bridges starting from Bus 0, Device 0, Function 0. When a bridge is found, the software will assign a unique bus number to the new bus that is larger than the bus number on which the bridge is located. Once the new bus is assigned a bus number, the software begins looking for a bridge on the new bus before continuing to scan for more bridges on the current bus.

Device is the device number, PCIe, allows a maximum of 32 device numbers on a single PCI bus. However, the point-to-point nature of PCIe means that only a single device can be directly connected to the PCIe link, and the device always ends up with device 0. RC and Switch have a virtual PCI bus that allows multiple devices to be “connected” to the bus. Each device must implement Function 0, and may contain a set of up to 8 Functions. When two or more Functions are included, the device is called a multi-function device.

Function is the a function number, as before, is included in each Device. These functions may include a hard disk interface, a display controller, an Ethernet controller, a USB controller, etc. The devices with multiple functions are not required to be implemented sequentially. For example, a device may implement Function 0, 2, and 7. Thus, when the software detects a multi-function device, every possible function must be checked to see which functions are present. Each Function also has its own configuration address space for setting up the associated resource.

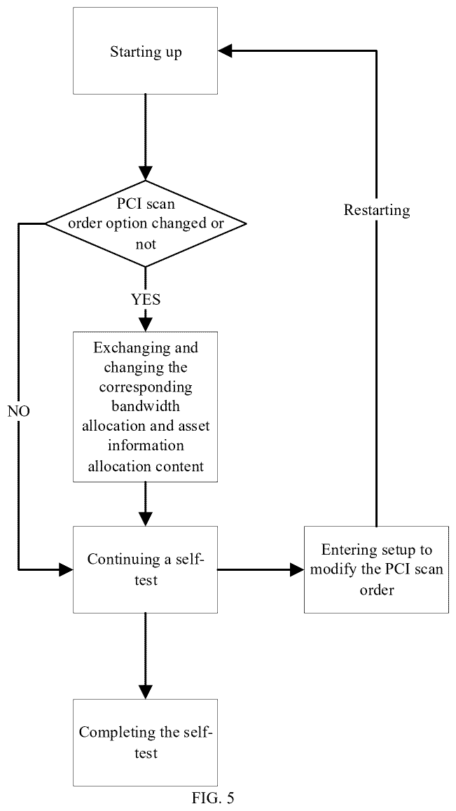

Referring to FIG. 5, it shows yet another flow diagram of a method for changing an identification order of the PCI device according to an embodiment of the present disclosure, which includes: starting up, and deciding whether the PCI scanning order option is changed. If the change occurs, the corresponding bandwidth allocation and asset information allocation content is exchanged and changed, and then it continues to execute the self-test program. If the change does not occur, it normally executes the self-test program. If the PCI scanning order is changed in the setup, the device is restarted to restart the start-up and confirm whether the scanning order is changed. The present disclosure significantly enhances the practicability of the BIOS, realizes the remote modification of the scanning order of the PCI without needing to go off-line to the scene. The realization can not only change the identification order of the PCI device, but also does not affect the performance, which greatly improves the practicability of the BIOS, and meets the requirements of a variety of test scenarios for customers.

The method of the present disclosure can also be applied to a special test at a software level such as an operating system when a user service changes or the order of PCI devices in the operating system is required to be repeatedly switched. It is difficult to modify an insertion method under a batch offline in a short time. For example, a large amount of manpower is required for a large batch modification, power failure is required, etc. In the case of a switch machine type, the insertion method may have a certain requirement, and changing the position of a switchboard may have a great influence on the performance and the underlying cpld firmware. At this time, by means of the PCI device identification method of the present disclosure, it is possible to quickly switch the order of the PCI devices in the operating system without affecting the hardware performance.

In an embodiment of the present disclosure, the method includes acquiring a configuration file of a processor; determining an identification order of each interface according to the configuration file, and generating an identification order list; modifying an identification order of a target interface in the identification order list by a basic input output system in response to an identification order modification request, and adjusting an order of port resource identifier corresponding to an interface of which the identification order is changed, to generate a new identification order list; and scanning a PCI device to which the processor is connected according to the new identification order list. The present disclosure provides a scheme that can modify the scanning order of PCI through BIOS, without the need to modify the insertion method of the device offline and without the need to cut off the power supply. The scanning order of the PCI device is modified in the software level, and the port resource identifier order corresponding to the interface of which the identification order is changed is modified synchronously, to ensure the correctness of the asset information corresponding to the PCI device. Since there is no need to worry that the performance of hardware is affected by the identification order, the identification order of the PCI device can be changed without affecting the performance.

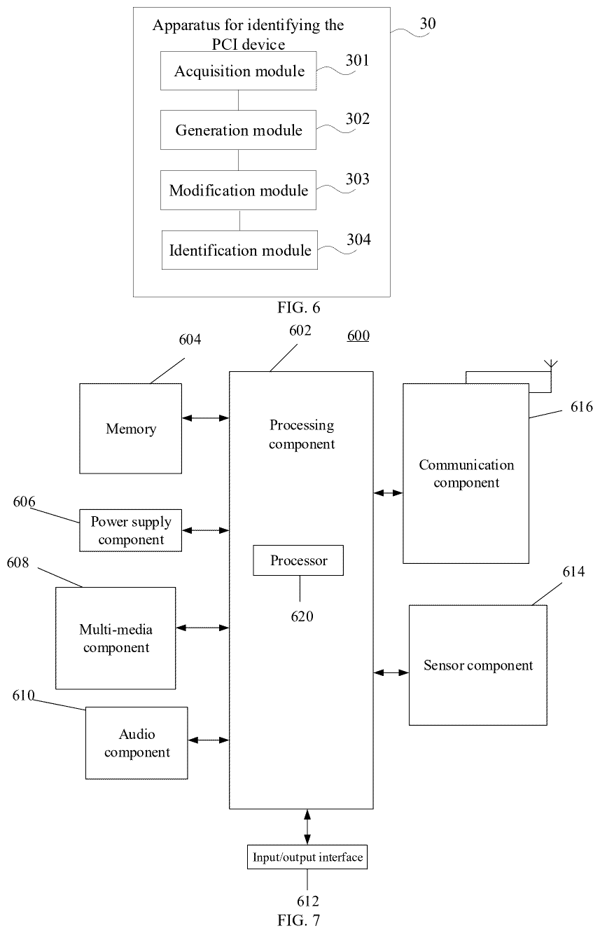

Referring to FIG. 6, it shows a block diagram of an apparatus for identifying the PCI device according to an embodiment of the present disclosure. The apparatus 30 includes:
an acquisition module 301 configured for acquiring a configuration file of a processor;
a generation module 302 configured for determining an identification order of each interface according to the configuration file, and generating an identification order list;
a modification module 303 configured for modifying an identification order of a target interface in the identification order list by a basic input output system in response to an identification order modification request, and adjusting an order of port resource identifier corresponding to an interface of which the identification order is changed, to generate a new identification order list; and
an identification module 304 configured for scanning a PCI device to which the processor is connected according to the new identification order list.

Optionally, the modification module includes:
a comparison sub-module configured for, after the basic input output system modifies the identification order of the target interface in the identification order list, comparing the adjusted identification order of the interface with a default identification order list to determine whether there is a change in the identification order of the interface; and
an adjustment sub-module configured for adjusting the order of port resource identifiers corresponding to the interface of which the identification order is changed in a condition that it is determined that there is a change in the identification order of the interface.

Optionally, the adjustment sub-module includes:
a determination unit configured for determining a target interface which identifies the order change; and
a modification unit configured for modifying the order of the port resource identifier, so that the order of the port resource identifier corresponds to the identification order of the modified target interface.

Optionally, the modification module includes:
a first display sub-module configured for displaying a menu option for adjusting the recognition sequence in a setting interface of the basic input output system;
a second display sub-module configured for displaying a default identification order list in response to a first input to the menu option; and
a modification submodule configured for modifying the identification order of the target interfaces in the identification order list in response to the identification order modification request for the identification order list.

Optionally, the modification sub-module includes:
a switching unit configured for exchanging the identification orders of any two interfaces in the identification order list in response to the identification order modification request for the identification order list.

Optionally, the generation module includes:
a model determination module configured for determining a model of the processor according to the configuration file; and
an identification order determination module configured for generating an identification order list based on the model of the processor.

Optionally, the model determination module includes:
a reading unit configured for reading a model identifier of the processor from the configuration file; and
a model determination unit configured for determining a model of the processor according to the model identifier.

Optionally, the identification order determination module includes:
a topology order determination module configured for determining an interface topology order of the processor according to the model of the processor; and
a ranking module configured for converting the interface topology order into an order arrangement, and generating an identification order list.

Optionally, the identification module includes:
an address acquisition sub-module configured for scanning an PCI device according to the new identification order list, and acquiring an address identifier of the PCI device;
a device information acquisition sub-module configured for acquiring relevant information about the PCI device according to the address identifier and outputting same; and
a self-test sub-module configured for continuing a self-test process of the next interface according to the identification order list.

Optionally, the device information acquisition sub-module includes:
a first output unit configured for acquiring a device type and manufacturer information about the PCI device and outputting same according to the address identifier; and
a second output unit configured for accessing a configuration space of the PCI device, and outputting configuration information about the PCI device, in a condition that the level of the PCI device complies with a pre-set level condition.

Optionally, the port resource identifier includes a bandwidth port identifier and an asset information port identifier.

Optionally, the address identifier is a BDF number, and wherein the BDF number includes a bus number, a device number, and a function number.

In an embodiment of the present disclosure, the method includes acquiring a configuration file of a processor; determining an identification order of each interface according to the configuration file, and generating an identification order list; modifying an identification order of a target interface in the identification order list by a basic input output system in response to an identification order modification request, and adjusting an order of port resource identifier corresponding to an interface of which the identification order is changed, to generate a new identification order list; and scanning a PCI device to which the processor is connected according to the new identification order list. The present disclosure provides a scheme that can modify the scanning order of PCI through BIOS, without the need to modify the insertion method of the device offline and without the need to cut off the power supply. The scanning order of the PCI device is modified in the software level, and the port resource identifier order corresponding to the interface of which the identification order is changed is modified synchronously, to ensure the correctness of the asset information corresponding to the PCI device. Since there is no need to worry that the performance of hardware is affected by the identification order, the identification order of the PCI device can be changed without affecting the performance.

FIG. 7 is a block diagram of an electronic device 600 shown according to some embodiments of the present disclosure. For example, the electronic device 600 may be a mobile phone, a computer, a digital broadcast terminal, a messaging device, a game console, a tablet device, a medical device, an exercise device, a personal digital assistant, etc.

Referring to FIG. 7, the electronic device 600 may include one or more of the following components: a processing component 602, a memory 604, a power supply component 606, a multimedia component 608, an audio component 610, an input/output (I/O) interface 612, a sensor component 614, and a communication component 616.

The processing component 602 generally controls the overall operation of the electronic device 600, such as operations associated with display, telephone calls, data communications, camera operations, and recording operations. The processing component 602 may include one or more processors 620 to execute instructions to perform all or part of the steps of the methods described above. In addition, the processing component 602 may include one or more modules to facilitate interaction between the processing component 602 and other components. For example, the processing component 602 can include a multimedia module to facilitate interaction between the multimedia component 608 and the processing component 602.

The memory 604 is used to store various types of data to support operation at the electronic device 600. Examples of such data include instructions for any present disclosure or method operating on the electronic device 600, contact data, phonebook data, messages, pictures, multimedia, and the like. The memory 604 may be implemented by any type or combination of volatile and non-volatile memory devices, such as a static random access memory (SRAM), an electrically erasable programmable read-only memory (EEPROM), an erasable programmable read-only memory (EPROM), programmable read-only memory (PROM), a read-only memory (ROM), a magnetic memory, a flash memory, a magnetic or optical disks.

The power supply component 606 provides power to the various components of the electronic device 600. The power supply components 606 may include a power management system, one or more power supplies, and other components associated with generating, managing, and distributing power to the electronic device 600.

The multimedia component 608 includes a screen of an output interface provided between the electronic device 600 and a user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense a touch, a slide, and a gesture on the touch panel. The touch sensor may not only sense the demarcation of a touch or slide action, but may also detect the duration and pressure associated with the touch or slide operation. In some embodiments, the multimedia component 608 includes a front camera and/or a rear camera. When the electronic device 600 is in an operation mode, such as a photographing mode or a multimedia mode, the front camera and/or the rear camera may receive external multimedia data. Each of the front camera head and the rear camera head may be a fixed optical lens system or have focal length and optical zoom capability.

The audio component 610 is used to output and/or input audio signals. For example, the audio component 610 includes a MIC for receiving external audio signals when the electronic device 600 is in an operational mode, such as a calling mode, a recording mode, and a voice recognition mode. The received audio signal may be further stored in the memory 604 or transmitted via the communication component 616. In some embodiments, the audio component 610 also includes a speaker for outputting audio signals.

The I/O interface 612 provides an interface between the processing component 602 and a peripheral interface module, which may be a keyboard, a click wheel, buttons, etc. These buttons may include, but are not limited to a home button, a volume button, a start button and a lock button.

The sensor component 614 includes one or more sensors for providing status evaluation of various aspects to the electronic device 600. For example, the sensor component 614 may detect an on/off state of the electronic device 600, a relative positioning of the components. For example, the component is a display and a keypad of the electronic device 600. The sensor component 614 may detect a change in position of the electronic device 600 or a component of the electronic device 600, the presence or absence of user contact with the electronic device 600, an orientation or acceleration/deceleration of the electronic device 600, and a change in the temperature of the electronic device 600. The sensor component 614 may include a proximity sensor configured for detecting the presence of a nearby object in the absence of any physical contact. The sensor component 614 may also include a light sensor, such as a CMOS or CCD image sensor, for use in imaging applications. In some embodiments, the sensor component 614 may also include an acceleration sensor, a gyroscope sensor, a magnetic sensor, a pressure sensor, or a temperature sensor.

The communication component 616 is used to facilitate wired or wireless communication between the electronic device 600 and other devices. The electronic device 600 may access a wireless network based on a communication standard, such as WiFi, a carrier network (e.g., 2G, 3G, 4G, or 5G), or a combination thereof. In some embodiments, the communication component 616 receives a broadcast signal or broadcast-related information from an external broadcast management system via a broadcast channel. In some embodiments, the communication component 616 also includes a near field communication (NFC) module to facilitate short-range communication. For example, the NFC module may be implemented based on RFID technology, IrDA technology, UWB technology, Bluetooth (BT) technology, and other technologies.

In some embodiments, the electronic device 600 may be implemented by one or more application specific integrated circuits (ASIC), digital signal processors (DSP), digital signal processing devices (DSPD), programmable logic devices (PLD), field programmable gate arrays (FPGA), controllers, micro-controllers, microprocessors, or other electronic components for implementing a method of identifying a PCI device as provided by an embodiment of the present disclosure.

In some embodiments, there is also provided a non-transitory computer non-volatile readable storage medium including instructions, such as a memory 604 including instructions executable by the processor 620 of the electronic device 600 to perform the above-described method. For example, the non-transitory storage medium may be an ROM, a RAM, a CD-ROM, a magnetic tape, a floppy disk, an optical data storage device, etc.

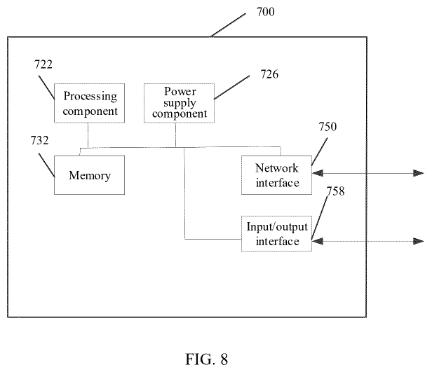

FIG. 8 is a block diagram of an electronic device 700 shown according to some embodiments of the present disclosure. For example, the electronic device 700 may be provided as a server. Referring to FIG. 8, the electronic device 700 includes a processing component 722 that further includes one or more processors and memory resources represented by the memory 732, for storing instructions, such as application programs, that may be executed by the processing component 722. The applications stored in the memory 732 may include one or more modules, each of which corresponds to a set of instructions. In addition, the processing component 722 is configured for executing instructions to perform a method for identifying a PCI device as provided by embodiments of the present disclosure.

The electronic device 700 may also include a power supply component 726 configured for performing power management of the electronic device 700, a wired or wireless network interface 750 configured for connecting the electronic device 700 to a network, and an input/output (I/O) interface 758. The electronic device 700 may operate based on an operating system stored in the memory 732, such as Windows Server™, Mac OS X™, Unix™, Linux™, FreeBSD™, or the like.

Embodiments of the present disclosure also provide a computer program product including a computer program which, when executed by a processor, implements a method for identifying a PCI device.

Other embodiments of the present disclosure will be apparent to those skilled in the art from consideration of the specification and practice of the present disclosure herein. The present disclosure is intended to cover any variations, uses, or adaptations of the application following the general principles of the present disclosure and including common knowledge or customary technical means in the art which are not disclosed in the present present disclosure. It is intended that the description and the examples be considered as exemplary only, with a true scope and spirit of the present disclosure being indicated by the claims.

It should be understood that the present present disclosure is not limited to the precise structures described above and shown in the accompanying drawings, and that various modifications and changes may be made without departing from the scope thereof. The scope of the present present disclosure is limited only by the appended claims.

1. A method for identifying a PCI device comprising:
acquiring a configuration file of a processor;
determining an identification order of each interface according to the configuration file, and generating an identification order list;
modifying an identification order of a target interface in the identification order list in a basic input output system in response to an identification order modification request, and adjusting an order of a port resource identifier corresponding to an interface of which the identification order is changed, to generate a new identification order list; and
scanning a PCI device to which the processor is connected according to the new identification order list.

2. The method according to claim 1, wherein the modifying an identification order of a target interface in the identification order list in a basic input output system, and adjusting an order of a port resource identifier corresponding to an interface of which the identification order is changed comprises:
after modifying the identification order of the target interface in the identification order list in the basic input output system, comparing the adjusted identification order of the interface with a default identification order list to determine whether there is a change in the identification order of the interface; and
adjusting the order of port resource identifiers corresponding to the interface of which the identification order is changed in a condition that it is determined that there is a change in the identification order of the interface.

3. The method according to claim 2, wherein the adjusting the order of port resource identifiers corresponding to the interface of which the identification order is changed in a condition that it is determined that there is a change in the identification order of the interface comprises:
determining a target interface which identifies the order change; and
modifying the order of the port resource identifier, so that the order of the port resource identifier corresponds to the identification order of the modified target interface.

4. The method according to claim 1, wherein the modifying an identification order of a target interface in the identification order list by a basic input output system in response to an identification order modification request comprises:
displaying a menu option for adjusting the recognition sequence in a setting interface of the basic input output system;
displaying a default identification order list in response to a first input to the menu option; and
modifying the identification order of the target interfaces in the identification order list in response to the identification order modification request for the identification order list.

5. The method according to claim 4, wherein the identification order is modified remotely by the basic input output system.

6. The method according to claim 4, wherein a first input is an input into a menu for adjusting the identification order.

7. The method according to claim 4, wherein the modifying the identification order of the target interfaces in the identification order list in response to the identification order modification request for the identification order list comprises:
exchanging the identification orders of any two interfaces in the identification order list in response to the identification order modification request for the identification order list.

8. The method according to claim 1, wherein the determining an identification order of each interface according to the configuration file, and generating an identification order list comprises:
determining a model of the processor according to the configuration file; and
generating an identification order list based on the model of the processor.

9. The method according to claim 8, wherein the determining a model of the processor according to the configuration file comprises:
reading a model identifier of the processor from the configuration file; and
determining a model of the processor according to the model identifier.

10. The method according to claim 8, wherein the generating an identification order list based on the model of the processor comprises:
determining an interface topology order of the processor according to the model of the processor; and
converting the interface topology order into an order arrangement, and generating an identification order list.

11. The method according to claim 1, wherein the scanning a PCI device to which the processor is connected according to the new identification order list comprises:
scanning an PCI device according to the new identification order list, and acquiring an address identifier of the PCI device;
acquiring information of the PCI device according to the address identifier and outputting same; and
continuing a self-test process of the next interface according to the identification order list.

12. The method according to claim 11, wherein the acquiring information about the PCI device according to the address identifier and outputting same comprises:
acquiring a device type and manufacturer information about the PCI device and outputting according to the address identifier; and
accessing a configuration space of the PCI device, and outputting configuration information about the PCI device, in a condition that the level of the PCI device complies with a pre-set level condition.

13. The method according to claim 12, wherein the method further comprises continuing a self-test procedure in a condition that the level of the PCI device does not comply with the pre-set level condition.

14. The method according to claim 12, wherein the configuration space is a register mapped to each interface card.

15. The method according to claim 14, wherein the method further comprises:
reading the configuration space of each of the interface cards by the basic input output system when a mainboard is powered on;
allocating a resource required by each of the interface cards by the basic input output system to obtain an allocation result; and
writing the allocation result into an address of the configuration space corresponding to each of the interface cards to complete automatic configuration of each of the interface cards.

16. The method according to claim 2, wherein the port resource identifier comprises a bandwidth port identifier and an asset information port identifier.

17. The method according to claim 12, wherein the address identifier is a BDF number, and the BDF number comprises a bus number, a device number, and a function number.

18. (canceled)

19. An electronic device, comprising a processor and a memory, wherein the memory stores a program or instructions executable on the processor, which when executed by the processor perform the steps of the method according to claim 1.

20. A non-volatile readable storage medium, wherein the non-volatile readable storage medium has stored thereon a program or instructions which when executed by a processor perform the steps of the method according to claim 1.

21. The electronic device according to claim 19, wherein the step of modifying an identification order of a target interface in the identification order list in a basic input output system, and adjusting an order of a port resource identifier corresponding to an interface of which the identification order is changed comprises:
after modifying the identification order of the target interface in the identification order list in the basic input output system, comparing the adjusted identification order of the interface with a default identification order list to determine whether there is a change in the identification order of the interface; and
adjusting the order of port resource identifiers corresponding to the interface of which the identification order is changed in a condition that it is determined that there is a change in the identification order of the interface.
